(19) United States
(12) Patent Application Publication
(10) Pub. No.: US 2025/0238980 A1
(43) Pub. Date: Jul. 24, 2025

(54) COMPUTER-IMPLEMENTED METHOD FOR IMAGE RECONSTRUCTION

(71) Applicant: Elekta Limited, Crawley (GB)

(72) Inventors: Nikita MORIAKOV, Crawley (GB); Jonas TEUWEN, Crawley (GB); Jan-Jakob Sonke, Amsterdam (NL)

(21) Appl. No.: 19/023,945

(22) Filed: Jan. 16, 2025

(30) Foreign Application Priority Data
Jan. 19, 2024 (GB) 2400758.5

(51) Int. Cl. G06T 11/00; G06T 7/00

(52) U.S. Cl. CPC G06T 11/006; G06T 7/97; G06T 2207/10081; G06T 2207/20081; G06T 2207/20084

(57) ABSTRACT

A computer-implemented method for image reconstruction using a learned iterative scheme, the method may comprise processing measured dual space data to reduce the resolution, initiating a reconstructed image in the primal space, determining dual and primal parameters defined in the dual and primal spaces, and identifying primal patches and dual patches. The method may further include iteratively updating the reconstructed image by applying a dual-space learned invertible operator to the dual parameters, applying a primal-space learned invertible operator to the primal parameters, updating the reconstructed image based on the updated primal parameters and, when necessary, based on upsampled primal parameters, upsampled dual parameters, and the upsampled reconstructed image. The method may also include outputting the updated reconstructed image.

### CLAIM FOR PRIORITY

This application claims the benefit of priority of British Application No. 2400758.5, filed Jan. 19, 2024, which is hereby incorporated by reference in its entirety.

### TECHNICAL FIELD

The present disclosure relates to image reconstruction. More particularly, the present disclosure relates to a method for image reconstruction using a learned iterative scheme and related computer program products, reconstruction nodes, and radiotherapy treatment apparatuses.

### BACKGROUND

Computed Tomography (CT) is one of the most used medical imaging modalities nowadays. Similar to many other modern imaging modalities such as MRI, the measurements acquired by a CT scanner—i.e., X-ray projection images taken from a multitude of angles—are not immediately usable in clinic and instead need to undergo the process of reconstruction, wherein they are processed by a reconstruction algorithm and combined into a three-dimensional volume. An important variation of CT is Cone Beam Computed Tomography (CBCT), where the X-ray source emits rays in a wide cone-shaped beam and the detector is a large flat panel array. In CBCT, both the X-ray source and the detector typically follow circular trajectories around the isocenter, and the detector is sometimes offset to give a larger field of view.

### SUMMARY

CBCT has applications in interventional radiology, dentistry and image-guided radiation therapy, however, CBCT image quality remains poor compared to classical CT with helical trajectory for a few reasons. CBCT reconstruction is inherently harder since the data completeness condition for exact reconstruction of the whole volume is not satisfied for circular source/detector orbits. Photon starvation, particularly in highly attenuated areas and in lower-dose scans, results in strong streaking artifacts. Scattering becomes a bigger issue as well, since a large detector panel captures more scattered photons from a wide cone beam of X-rays. Resulting poor Hounsfield Unit (HU) calibration is a limiting factor for applications in e.g. adaptive radiotherapy, where a daily CBCT scan for treatment plan adjustment without the need for registration to a prior CT scan would be very desirable.

Deep learning reconstruction methods have drawn interest from the medical imaging community by achieving effective results in public reconstruction challenges such as FastMRI. Reconstruction methods in the learned post-processing family apply a neural network as a learned operator on top of a classical reconstruction method such as filtered back-projection (FBP). Despite the advantages such as typically fast inference, learned post-processing methods do not provide the neural network with direct access to the underlying measurement data, thus some imaging artifacts might be hard to fix. For example, removing streaks due to photon starvation in CBCT in image domain would require a neural network with large receptive field due to the size of the streaks. Learned iterative schemes, on the other hand, are inspired by classical iterative methods such as Landweber iteration, and embed the forward operator directly in the neural network architecture. Intuitively, this allows to draw on the theoretical guarantees given by iterative methods but use more flexible ‘neural network prior’ instead of an explicit regularization. Learned Primal-Dual (LPD) algorithm is a prominent example of a learned iterative scheme inspired by the Primal-Dual Hybrid Gradient (PDHG) method, which combines both image-space and projection-space operations in an end-to-end trainable network. Image-space computations are performed by primal blocks and projection-space computations are performed by dual blocks, all primal/dual blocks being small convolutional neural networks (CNNs). LPD framework has been extended to other modalities as well, such as Digital Breast Tomosynthesis and MRI, but there are also recent examples of learned iterative schemes for CT or MRI reconstruction that work in image domain only.

However, learned iterative schemes and LPD in particular can be hard to scale up to a fully three-dimensional modality such as CBCT due to memory limitations. For example, given a 256×256×256 FP32 tensor, a single convolution layer with 64 features would already require 8 GB memory to perform the backpropagation operation. One of the first memory-efficient alternatives is ∂U-Net, which is a simpler scheme that does not operate in the projection space. Memory usage is reduced by relying on a multiscale approach, where reconstructions obtained at different resolutions are merged together by a final Unet. ILPD, or invertible learned primal-dual method, has been considered, where it was shown that it substantially reduces memory requirements and allows to use longer learned iterative schemes. For a 3D helical CT setting, iLPD has been combined with splitting the scanning geometry in chunks of data that can be processed independently, however, such geometry splitting is not possible for CBCT. To address this issue, LIRE (learned invertible reconstruction) method was recently proposed, where a learned invertible primal-dual scheme was augmented with tiling computation mechanism inside the primal/dual blocks during both training and inference, allowing to use higher filter counts as well as more complex U-net cells inside primal blocks. LIRE inference takes around 30 seconds on NVIDIA A100 accelerator with clinically relevant geometry and resolution, and it is desirable to speed it up for future clinical application.

Parallel to the development of new learned iterative schemes for reconstruction, the study of natural symmetries of learning tasks and the means of building these symmetries into neural network architectures has been a fruitful recent research direction in inverse problems and deep learning in general. For instance, when a patient is rotated, one expects the new reconstruction to be a rotated version of the original reconstruction. For convolutional neural networks, this problem is addressed with group equivariant convolutions, which often allow to achieve state of the art results at reduced parameter cost on image classification tasks. Group equivariant convolutional neural networks have been applied to inverse problems with learned iterative schemes as well, but not in the context of CBCT and learned-primal dual family of methods. Additionally, even though group equivariant convolutional neural networks allow one to reduce the parameter cost, the dimensionality of internal representations is typically increased resulting in increased inference times. This is the consequence of a rule of thumb, where the number of filters is reduced by the square root of the group size to approximately match the total parameter count. Therefore, including group-equivariant operations in CBCT reconstruction further necessitates the search for fast and memory efficient learned iterative schemes.

According to an aspect of the present disclosure, there is provided a computer-implemented method for image reconstruction using a learned iterative scheme. The method includes a step of obtaining measured data defined in a dual space, the measured data relating to a primal space. The method then includes a step of processing the measured data to reduce a resolution of the measured data by a first factor. Here, some of the measured data (or projections) may be skipped to reduce the resolution and/or the measured data may be downsampled. The method includes a step of initiating a reconstructed image in the primal space based on the processed measured data. For instance, back-projection, filtered back-projection, or an iterative method may be used to initialise the reconstruction. The initial reconstruction is performed at reduced resolution.

The method then includes a step of determining initial dual parameters defined in the dual space based on the processed measured data. The method also includes a step of determining initial primal parameters defined in the primal space based on the initiated reconstructed image. The method includes a step of identifying a plurality of primal patches, each primal patch representing a subvolume of the primal space. The primal space is divided into the plurality of the primal patches. The method includes a step of identifying a plurality of dual patches, each dual patch representing a subset of the dual space. The dual space is divided into the plurality of the dual patches.

The method includes a step of iteratively updating the reconstructed image by iteration of steps (a), (b), and (c) as follows. Step (a) involves applying a dual-space learned invertible operator to the dual parameters, in dependence on at least part of the dual parameters, to obtain updated dual parameters. For instance, the update to the dual parameters may be computed using part of the dual parameters, the processed measured data, part of the projected primal parameters, and the current reconstructed image (where the current reconstructed image and part of the primal parameters are projected). The dual-space learned invertible operator is calculated separately for each dual patch. Step (b) involves applying a primal-space learned invertible operator to the primal parameters, in dependence on at least part of the primal parameters, to obtain updated primal parameters. For instance, the update to the primal parameters may be computed using part of the primal parameters, part of back-projected dual parameters, the current reconstruction, a Landweber term, and an auxiliary field of view tensor (see example provided below). The primal-space learned invertible operator is calculated separately for each primal patch. Step (c) involves updating the reconstructed image based on the updated primal parameters.

In more detail, iteratively updating the reconstructed image includes performing a first plurality of iterations of steps (a), (b), and (c). The iterative updating then involves processing the updated primal parameters, updated dual parameters, and updated reconstructed image to increase a resolution of the updated primal parameters, updated dual parameters, and updated reconstructed image. The iterative updating then involves performing at least one additional iteration of steps (a), (b), and (c). That is, preceding the output of the updated reconstruction image, the reconstructed image and the primal- and dual parameters are upsampled to an increased (e.g., original) resolution. The skilled reader will appreciate that the factor may correspond to any suitable fraction of the original resolution (for instance, 50% or 25%). That is, a first plurality of iterations (e.g., 6 iterations) may be performed using at a resolution (first factor) of 50% of the original measured data before additional iterations (e.g., a further 6 iterations) may be performed at the original (100%) resolution.

Further, the skilled reader will appreciate that more than two “scales” (i.e., original and the scale defined by the first factor) may be used in embodiments. For instance, a first plurality of iterations may be performed using the first factor (e.g., 25%) before a second plurality of iterations may be performed using a second factor (e.g., 50%), and then a final number of iterations may be performed at the original (100%) resolution. When three scales are used (e.g., 25%, 50%, 100%), the upsampling process may be performed twice. Consequently, the iterative updating may comprise at least one additional iteration of steps (a), (b), and (c) as well as an additional iteration of the step of increasing resolution of the updated primal parameters, updated dual parameters, and updated reconstructed image.

The method outputs the updated reconstructed image (or any/all reconstructions obtained at different time steps). The invertible nature of the dual-space learned invertible operator and the primal-space invertible operator allows to calculate gradients of model parameters more efficiently. The patches reduce the amount of memory necessary to apply the learned invertible operators. Therefore, training of the learned operators is more effective. This may lead to more accurate and/or more efficient reconstruction. The invertibility of the learned operators allows to reduce the amount of memory needed during the training of the learned operators. Moreover, the patch-wise calculation of the learned invertible operators helps to reduce the memory needed to perform said calculations.

This introduction of multiscale reconstruction improves inference speed for the same image quality, and enables use of more simple primal blocks (contained in the primal-space learned invertible operator). Notably, combining learned invertible primal-dual scheme and multiscale reconstruction may appear counterintuitive, since the input and the output in a reversible neural network have the same dimensionality.

Techniques according to the present disclosure provide a faster and more parameter-efficient learned primal-dual scheme relative to known techniques, while yielding similar or better reconstruction quality. The present disclosure additionally enjoys rotational equivariance for improved robustness to unusual patient orientation. Extensive comparative evaluation of techniques according to the present disclosure (often referred to herein as LIRE₊) and the baselines using image quality metrics such as PSNR and Structural Similarity Index Measure (SSIM) as well as HU Mean Absolute Error (MAE) are provided below.

Optionally, each of the dual-space learned invertible operator and primal-space learned invertible operator may comprise a convolutional neural network. The architecture of the primal blocks may be simpler (e.g., fewer convolutional layers, underlying nodes and/or interconnections) than that of primal blocks used in known techniques, including LIRE, owing to the use of multiscale reconstruction in the present disclosure. The primal-space learned invertible operator may comprise an equivariant convolutional neural network. Additionally or alternatively, the dual-space learned invertible operator may be an equivariant convolutional network, for instance, with respect to mirror operations that flip top and bottom of the image subject. In an example, the primal-space operator may be equivariant with respect to rotations. Of course, the operator may alternatively or additionally be equivariant with respect to mirroring operations. In some examples, both primal and dual space networks may be equivariant with respect to certain transformation groups, such as the group of 90-degree rotations in primal space and trivial group in dual space.

Optionally, processing the measured data to reduce a resolution of the measured data by a first factor comprises downsampling the measured data to a resolution reduced by the first factor. Optionally, processing the measured data to reduce a resolution of the measured data by a first factor comprises subsampling the measured data by a parameter that is determined by the first factor. That is, either one of or both downsampling and subsampling may be applied to reduce the resolution of the measured data. For example, if the first factor is 50%, then the measured data may be downsampled to 50% resolution and have every second measurement data point (for example every second projection) dropped.

Optionally, processing the updated primal parameters, updated dual parameters, and updated reconstructed image to increase a resolution of the updated primal parameters, updated dual parameters, and updated reconstructed image, comprises performing an injective function or process on the updated primal parameters, updated dual parameters, and updated reconstructed image. Use of an injective process or function ensures that the invertibility of the overall network is not lost, ensuring that the memory advantages afforded by this feature are maintained.

Optionally, processing the updated primal parameters, updated dual parameters, and updated reconstructed image to increase a resolution of the updated primal parameters, updated dual parameters, and updated reconstructed image, comprises performing a nearest upsampling operation.

Optionally, initiating a reconstructed image in the primal space based on the processed measured data comprises performing at least one of a backprojection reconstruction technique and an iterative reconstruction technique. The backprojection could, for example, be a filtered backprojection (also known as analytic reconstruction, e.g., FDK). Generally, all classical reconstruction methods without deep learning are either analytic reconstruction (variation of filtered backprojection, such as FDK) or iterative reconstruction. Starting with reconstruction initialized with zeros is of course a possibility, but is suboptimal. One could take projection data and apply a pre-processing procedure (such as scatter removal or beam hardening corrections) before providing it as an input to the method.

Optionally, iteratively updating the reconstructed image includes a step of calculating auxiliary dual parameters based on at least part of the primal parameters. The dual space learned invertible operator is further dependent on the auxiliary dual parameters. Further optionally, the iterative updating includes a step of calculating auxiliary primal parameters based on at least part of the dual parameters. The primal space learned invertible operator is further dependent on the auxiliary primal parameters. This may improve the reconstruction by providing a way for the dual-space learned invertible operator to take into account at least part of the primal parameters, and for the primal-space learned invertible operator to take into account at least part of the dual parameters.

Optionally, calculating the auxiliary dual parameters may comprise forward-projecting at least part of the primal parameters. Similarly, calculating the auxiliary primal parameters may comprise back-projecting at least part of the dual parameters. Optionally, for the first plurality of iterations, forward-projecting at least part of the primal parameters, and back-projecting at least part of the dual parameters, comprises computing the projection or back-projection for a subset of the original measurement data. The subset is determined by the first factor. Here, the projection would be computed at reduced resolution and the backprojection will be applied to lower-resolution data (that is, the process uses a subset of projection data at reduced resolution). This provides an efficient manner to calculate the auxiliary dual parameters and the auxiliary primal parameters.

That is, the first factor has an effect on the forward and back projections during the first plurality of iterations. The subset may comprise every x-th projection from the original data, where the parameter x corresponds to the first factor, for instance every second projection for a first factor of 50%. When back projection is used to initiate the reconstructed image, this process may also be performed on a subset of the processed data, for instance on every second projection if the first factor is 50%. As above, of course, the skilled reader will appreciate that the precise form of projection and backprojection here depends on the scaling factor (the projection resolution and projection count). The first factor may take values such as 25%, 50% and 100%.

Optionally, calculating the auxiliary dual parameters may further comprise forward-projecting the updated reconstructed image in the primal space. The primal-space learned invertible operator may then be further dependent on the updated image.

Optionally, the method may further comprise a step of organizing the dual parameters in a plurality of dual channels and dividing the dual channels into first dual channels containing first dual parameters and second dual channels containing second dual parameters. Each dual channel may correspond to the dual space. The method may further comprise a step of organizing the primal parameters in a plurality of primal channels and dividing the primal channels into first primal channels containing first primal parameters and second primal channels containing second primal parameter. Each primal channel may correspond to the primal space. This provides a particularly flexible and efficient way to implement the learned invertible operators.

Optionally, applying the dual-space learned invertible operator to the dual parameters may comprise updating the second dual parameters based on an output of a dual-space learned model without changing the first dual parameters. The output of the dual-space learned model may be calculated separately for each dual patch. Optionally, applying the primal-space learned invertible operator to the primal parameters may comprise updating the second primal parameters based on an output of a primal-space learned model without changing the first primal parameters. The output of the primal-space learned model may be calculated separately for each primal patch. For each operator, the model may be a neural network, such as the convolutional neural networks described above. This provides a particularly flexible and efficient way to implement the learned invertible operators.

Optionally, in cases in which calculating the auxiliary dual parameters comprises forward-projecting at least part of the primal parameters, calculating the auxiliary dual parameters comprises forward-projecting the second primal parameters. Similarly, in cases in which calculating the auxiliary primal parameters comprises back-projecting at least part of the dual parameters, calculating the auxiliary primal parameters comprises back-projecting the second dual parameters.

Optionally, the method may further include a step of permuting the dual channels to mix the first dual channels and the second dual channels. The method may also include a step of permuting the primal channels to mix the first primal channels and the second primal channels. The permuting steps may take place at the end of each iteration of steps (a), (b), and (c). Mixing the channels helps to obtain better reconstruction results with the learned invertible operators.

Optionally, the method may further include a step of calculating an error term based on the updated reconstructed image in the primal space and the processed measured data defined in the dual space. At least one of the primal-space learned invertible operator and the dual-space learned invertible operator may be dependent on the error term. The calculation of the error term may take place during each iteration of steps (a), (b), and (c). This may help the respective learned invertible operator to correct the error in the next iteration.

Optionally, the method may further include a step of applying weight normalization to parameters of the primal-space learned invertible operator and/or of the dual-space learned invertible operator. Of course, various weight normalization schemes may be used, such as weight normalization without centering.

Optionally, primal patches and dual patches may overlap each other. For instance, the patches may have an overlap at their boundaries, where the size of this intersection may be dependent on the CNN architecture that is used for the primal and/or dual blocks. This helps to ensure correct calculation for each patch, in particular to calculate e.g. convolutions.

Optionally, the subset of the dual space may comprise a rectangular area of a projection. The subset of the dual space may comprise an area of a two-dimensional projection image, as well as one or more projection directions. For example, the subset of the dual space may comprise an area of a two-dimensional projection image and an angular range of projection directions, thus forming a rectangular region in dual space. This allows for an effective patchwise calculation of e.g. convolutions and/or filters.

Optionally, the measured data may comprise cone-beam X-ray projection data. Moreover, the following detailed examples concentrate on cone-beam computed tomography (CBCT). However, the techniques of the present disclosure are not limited to CBCT. Indeed, the techniques may be applied to a broader range of computed tomography systems, such as fan-beam CT and spiral CT. Moreover, the techniques may be applied to magnetic resonance imaging (MRI) and other reconstruction systems that have a primal-dual architecture, such as positron emission tomography (PET), single-photon emission computed tomography (SPECT), echography, and sonography.

Optionally, the method may further include training the dual-space learned invertible operator and the primal-space learned invertible operator, based on a training dataset. By the training, the learning of the learned invertible operators takes place by choosing the parameters of the learned invertible operators to minimize an error when the learned iterative scheme is applied to samples from the train set.

Optionally, in each iteration, the method may further include a step of updating the image in the primal space based on the updated primal parameters. This way, the image may be stored in each intermediate step, which may be helpful to calculate gradients when training the learned iterative scheme.

Optionally, the method may further include a step of obtaining an updated image in the primal space by updating the image in the primal space based on the updated primal parameters. The calculating of the auxiliary dual parameters may further comprise forwardprojecting the updated image in the primal space. Moreover, the primal-space learned invertible operator may be further dependent on the updated image. This helps to provide improved reconstructions.

Embodiments of another aspect include a computer program product comprising instructions, which, when executed by computer, causes the computer to execute a computer-implemented method for image reconstruction using a learned iterative scheme.

Embodiments of another aspect include a non-transitory computer-readable storage medium comprising instructions, which, when executed by a computer, cause the computer to execute a computer-implemented method for image reconstruction using a learned iterative scheme.

Embodiments of another aspect include a data processing apparatus, such as a reconstruction node, which comprises a memory and processing circuitry. The memory stores computer-executable instructions to carry out a computer-implemented method for image reconstruction using a learned iterative scheme. The processor is configured to execute the instructions.

Embodiments of another aspect include a radiotherapy treatment apparatus, which includes a data processing apparatus such as a reconstruction node, and configured to carry out a computer-implemented method for image reconstruction using a learned iterative scheme.

The present disclosure may be implemented in digital electronic circuitry, or in computer hardware, firmware, software, or in combinations thereof. The present disclosure may be implemented as a computer program or a computer program product, i.e., a computer program tangibly embodied in a non-transitory information carrier, e.g., in a machine-readable storage device or in a propagated signal, for execution by, or to control the operation of, one or more hardware modules.

A computer program may be in the form of a stand-alone program, a computer program portion, or more than one computer program, and may be written in any form of programming language, including compiled or interpreted languages, and it may be deployed in any form, including as a stand-alone program or as a module, component, subroutine, or other unit suitable for use in a data processing environment. A computer program may be deployed to be executed on one module or on multiple modules at one site or distributed across multiple sites and interconnected by a communication network.

Method steps of the present disclosure may be performed by one or more programmable processors executing a computer program to perform functions of the present disclosure by operating on input data and generating output. Apparatus of the present disclosure may be implemented as programmed hardware or as special purpose logic circuitry, including e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions coupled to one or more memory devices for storing instructions and data.

The present disclosure is described in terms of particular embodiments. Other embodiments are within the scope of the following claims. For example, the steps of the present disclosure may be performed in a different order and still achieve desirable results.

Elements of the present disclosure have been described using such terms as “processor” and “input device”. The skilled person will appreciate that such functional terms and their equivalents may refer to parts of the system that are spatially separate but combine to serve the function defined. Equally, the same physical parts of the system may provide two or more of the functions defined. For example, separately defined means may be implemented using the same memory and/or processor as appropriate.

### BRIEF DESCRIPTION OF THE DRAWINGS

Reference is made, by way of example only, to the accompanying drawings in which:

FIG. 1 is a flowchart of a general method for image reconstruction using a learned iterative scheme according to embodiments;

FIG. 2 is a set of metrics comparing the efficacy of embodiments to baselines, for thorax CT data for straight patient orientation;

FIG. 3 is a set of metrics comparing the efficacy of embodiments to baselines, for thorax CT data for rotated patient orientation;

FIG. 4 is a comparative set of ground truth and reconstructed axial slices for thorax CT data;

FIG. 5 is a comparative set of difference maps for ground truth and reconstructed axial slices for thorax CT data;

FIG. 6 is a comparative set of ground truth and reconstructed coronal slices for thorax CT data;

FIG. 7 is a comparative set of difference maps for ground truth and reconstructed coronal slices for thorax CT data;

FIG. 8 is a comparative set of ground truth and reconstructed axial slices for head and neck CT data; and

FIG. 9 is a block diagram of a radiotherapy system for implementation of methods according to embodiments.

### DETAILED DESCRIPTION

CBCT reconstruction can be viewed as an inverse problem. The cone-beam transform operator, or simply the projection operator, may be defined as an integral operator:

$$𝒫 ( x ) ( t , u ) = {\int }_{{L}_{t , u}} x ( z ) dz ,$$

where x: Ω_{X}→R is a function specifying attenuation coefficients in the spatial domain Ω_{X}⊂ [symbol] and L_{t,u} is a line from the source to the detector element u at time t. [symbol] is a linear operator, and Hermitian adjoint [symbol] (for suitably defined L² function spaces) of [symbol] is called the backprojection operator. Using the projection operator [symbol] , one may model noisy CBCT acquisition as

$$y = Poisson ( {I}_{0} \cdot {e}^{- 𝒫 x} ) ,$$

where I₀ is the unattenuated X-ray photon count. The inverse problem of CBCT reconstruction is then to determine the tissue attenuation coefficients x from the noisy projection data y.

One may approach the inverse problem by finding a Bayes estimator parametrized by a neural network. The goal for the Bayes estimator \hat{x}_{Bayes} in general is to minimize the expected cost

$$L ( \hat{x} ) = {𝔼}_{( x , y ) - π} L ( x , \hat{x} ( y ) )$$

over all estimators \hat{x}, where π is the distribution of pairs (x, y) of tomographic volumes x with the corresponding projection images y, and L is a fixed cost function. Herein, a sum of mean absolute error and a Structural Similarity loss will play the role of the cost function L, the optimal estimator will be chosen from a certain class of neural networks, and minimization of the cost with respect to the parameters of the network will be carried out via minibatch stochastic gradient descent. The skilled reader will, of course, appreciate that other conventions may be used. The reader is directed to Section 5.1.2 in the work of J. Kaipio and E. Somersalo (Statistical and Computational Inverse Problems, volume 160 of Applied Mathematical Sciences, Springer-Verlag, New York, 2005) for more information on Bayes estimators.

Techniques according to the present disclosure (again, referred to herein as LIRE₊) may be understood as an unrolled learned iterative scheme, which extend known techniques such as LIRE by relying on multiscale reconstruction strategy to improve the inference speed, equivariant primal cells for higher parameter efficiency and robustness to orientation, and optionally centred weight normalization to improve convergence stability. Similar to LIRE, the memory footprint of techniques according to the present disclosure is reduced by combining invertibility for the network as a whole and patch-wise computations for local operations. An optional CPU-GPU memory streaming mechanism is implemented, which would keep entire primal/dual vectors in CPU memory and only send the patch required for computing the primal/dual updates or gradients into the GPU. The reader is referred to the original work of LIRE for a discussion on invertibility and patch-wise computations (see international application, publication number WO 2023/156242 A1).

Techniques herein provide a practical framework for deep learning-based CBCT reconstruction with clinically-relevant resolution and projection count using a learned iterative scheme that can be trained end-to-end on current consumer GPUs. For example, a GPU of about 24 GB VRAM may be sufficient in certain applications. The framework comprises a learned primal-dual iterative scheme with residual primal-dual blocks. Moreover, a set of optional memory optimization techniques may be embedded in the algorithm.

Different models may be trained for clinical CBCT geometries with differently sized field-of-view. For example, two models may be trained for large and small field of view, respectively. In certain implementations, the large field-of-view may be accomplished by a detector panel with an offset. In clinical CBCT scanners, panel size may be fixed but the panel itself can be offset so that the source-isocenter line intersects the panel off-center. The offset direction is parallel to the direction of rotation in the “detector panel space”. Such offset detector panel then would give larger field of view when it goes through a full 360-degree rotation.

Improved out-of-distribution generalization of certain embodiments of the present method compared to a deep learning baseline was demonstrated for both geometries on a test data set of head & neck CT scans, where the method improves upon analytical and iterative baselines as well.

Techniques herein comprise a reversible primal-dual iterative scheme. To compute the gradients, only the final latent vectors and the sequence of reconstructions returned by the algorithm may be needed. This allows to use longer schemes.

Techniques herein may make use of the local nature of Convolutional Neural Networks (Unet included). For example, certain embodiments perform patch-wise computations inside the primal-dual blocks during both training and evaluation. During backpropagation, weight gradients received from different patches may be combined, for example by summation, giving correct global gradients for the network weights.

Techniques herein may be able to use 3D U-nets with a relatively high filter count inside the primal blocks. Conceptually, the framework allows to use U-nets in both primal and dual blocks, which can be important for scatter correction but also when applying this framework to other modalities such as MRI. Of course, alternative networks may be used inside primal (and dual blocks), such as those that add multiscaling in order to compensate for smaller receptive field size of blocks. Again, primal blocks and/or dual block may use equivariant cells including rotational equivariant cells and/or mirroring equivariant cells.

In techniques herein, the network has an auxiliary scalar tensor which has the same shape as the reconstructed volume. In this tensor, intensity of a given voxel contains information about the percentage of projections for which the corresponding spatial location is visible. The network may be trained to reconstruct the intensities of all voxels which are visible in at least one projection. This may result in a larger field-of-view than FBP.

In techniques herein, the reconstruction scheme may maintain a separate variable for the current iteration of reconstruction. The algorithm may return all resulting intermediate reconstructions. The training loss may then be computed as the sum of reconstruction losses of these intermediate approximations. This way a better supervision may be realized. Moreover, potential gradient vanishing effects may be reduced. Additionally, the algorithm can be stopped early during inference.

Some techniques herein supply a Landweber update term as additional input for the primal blocks. The Landweber update term is known, by itself, from e.g. the work of Kaipio, J., & Somersalo, E. (Statistical and Computational Inverse Problems, volume 160 of Applied Mathematical Sciences. Springer-Verlag, New York. 2005). For example, the Landweber update term may be an analytically filtered Landweber term. For example, instead of using a raw Landweber term, a filtered backprojection may be applied instead of the (unfiltered) backprojection that appears in the Landweber update term of Line 15 in Algorithm 1 (see below). Other variations of the Landweber term and other kinds of update term or error term may be used as alternative to the Landweber term.

Discussed herein, ‘learned invertible reconstruction’ (hereinafter: LIRE) is a data-driven algorithm, wherein a learned iterative scheme is unrolled and the parameters of this scheme are jointly optimized to minimize expected reconstruction loss over the training dataset. The choice of a particular scheme will, naturally, affect both the performance and the used resources such as GPU memory to train such a scheme.

As disclosed herein, a system for image reconstruction may contain reversible residual neural network layers. In a reversible residual network layer, the input tensor z may be split into tensors z₁, z₂ along the channel dimension. The output w of the layer is then defined by combining z₁ and z₂+Λ(z₁) back along the channel dimension, wherein Λ is a neural network, for example a Convolutional Neural Network. Herein, Λ(z₁) denotes the output of the neural network A in response to the input z₁. Thus, the second tensor z₂ is augmented based on the output of the neural network ∧ in response to the first tensor z₁. The output comprises the concatenation of the first tensor z₁ and the augmented second tensor z₂+Λ(z₁). In such a configuration, the input z can be uniquely restored from the output w up to numerical errors, which are typically negligible in practice for small neural networks. Since the input z can be uniquely restored from the output w, it is not necessary to store intermediate features of the neural network Λ prior to the actual computation of gradients for the neural network Λ.

For neural networks that are composed of local operators such as valid convolutions, activation functions, upsampling and downsampling layers, it is possible to partition the input tensor z into patches zᵢ, i=1, . . . , k along the spatial dimensions and compute the output patch-by-patch. In general, for every i it may be also useful to enlarge the patch zᵢ by adding all tensor elements ∂zᵢ⊂z within a certain distance to zᵢ in order to account for the receptive field of the network when computing features for locations inside zᵢ.

To justify the combination of multiscale reconstruction and invertibility, one makes the following observation: if Λ: [symbol] → [symbol] is an invertible neural network and ι: [symbol] → [symbol] , m≥n is some fixed injective differentiable mapping such as nearest upsampling operation, then the input×∈ [symbol] can be restored from the output: ι(Λ(x))∈ [symbol] unambiguously by first inverting i and then Λ, so the gradients for the parameters of Λ can be computed without storing the activations during the forward pass. An example of the algorithm was implemented as a C++/CUDA extension for PyTorch in order to maximize memory efficiency, training and inference speed.

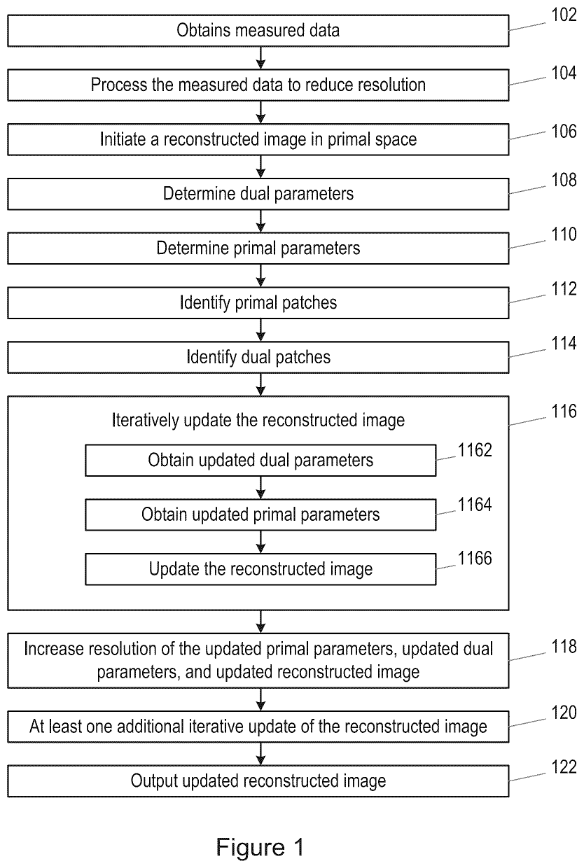

FIG. 1 is an overview of a general method for image reconstruction using a learned iterative scheme. As a preliminary step (not illustrated) a number of algorithmic parameters may be determined, such as parameters of learned models and other algorithm parameters such as a number of channels to be used for storing intermediate results and a number of iterations to perform, what permutations to perform on the channels, and so on. The method may be implemented on computing means.

At 102, the computing means obtains measured data. In certain embodiments, in particular when used to train the reconstruction algorithm, the measurement data could be generated artificially. However, in daily practice when reconstructing an image, the measurement data may be data obtained from an acquisition apparatus including a plurality of sensors. The data may be pre-processed, for example smoothed or outliers may be removed. The measurement data is defined in a dual space, for example a space consisting of a plurality of projections of a primal space (i.e., projection space). The measured data relates to a primal space (i.e., image space).

At 104, the computing means processes the measured data (see, e.g., Algorithm 1, Line 3 below). This involves reduction of the resolution of the measured data by a first factor, such as 50% or 25%, etc.

At 106, the computing means initiates or initialises a reconstructed image in the primal space based on the processed measured data (see, e.g., Algorithm 1, Line 4 below). The image may be generated by back-projecting the measurement data. For example, a normalized backprojection may be employed. For example, the back-projection may be unfiltered or filtered using a certain filter such as ramp filter. Alternative classical reconstruction methods, e.g., iterative reconstruction with total variation (TV) regularization, can be used for the initial reconstruction as well. This step helps to improve the computational efficiency and may also provide better capability of the learned models to perform corrections. A list of intermediate reconstructions may be created, this list may be extended during the procedure by adding newly created reconstructions to the list. In general, the image is defined in a primal space. The primal space may for example correspond to a volume in the real world.

At 108, the computing means determines dual parameters defined in the dual space based on the processed measured data (see, e.g., Algorithm 1, Line 8 below). At 110, the computing means determines primal parameters defined in the primal space based on the initiated reconstructed image (see, e.g., Algorithm 1, Line 7 below). For instance, a primal vector, consisting of the primal parameters defined in the primal space, may comprise a number of components called channels. Each channel may comprise data of an image in the primal space. Thus, each pixel or voxel of the primal space may be represented by a pixel in each primal channel. Initially, each channel may be initialized to be equal to the initial back-projected image. So, initially the primal vector may contain a number of copies of the initial back-projected image. In alternative embodiments, for example, one or more or each copy may be perturbed a bit using a random noise, for example. Yet alternatively, the primal parameters could be initialized to zero. Similarly, a dual vector, comprising dual parameters defined in the dual space, may be divided up into a number of components called channels. Each channel of the dual vector may comprise data in the dual space. For example, each pixel of a projection may be represented by a pixel (parameter) in each dual channel. Initially, each channel may be initialized to be equal to the measured data. So, initially the dual vector may contain a number of copies of the measured data. However, this is not a limitation. In alternative embodiments, for example, one or more or each copy may be perturbed a bit using a random noise, for example, or filtered, for instance, similarly to the filtering in FBP reconstruction method.

Preferably the number of channels in both the dual vector and the primal vector is an even number. For example, that number is 8, 10, or 12 channels. Also, the number of channels of the dual vector may be equal to the number of channels of the primal vector, however in certain embodiments it may also be a different number of channels.

At 112, the computing means identifies a plurality of primal patches, where each primal patch represents a subvolume of the primal space, and where the primal space is divided into the plurality of the primal patches. At 114, the computing means identifies a plurality of dual patches, where each dual patch representing a subset of the dual space, and where the dual space is divided into the plurality of the dual patches. For example, the input tensor may be broken up into small regions, such as rectangular blocks, along all three axes, corresponding to the spatial dimensions for primal update and to the two detector dimensions plus the projection dimension for the dual update. In certain embodiments, these patches include additional overlapping boundary regions to allow for e.g. valid convolutions.

At 116, the computing means performs an iterative process of updating the reconstructed image as follows.

At 1162, the computing means applies a dual-space learned invertible operator to the dual parameters, in dependence on at least part of the dual parameters (see, e.g., Algorithm 1, Line 13 below). This process obtains updated dual parameters. The dual-space learned invertible operator is calculated separately for each dual patch.

At 1164, the computing means applies a primal-space learned invertible operator to the primal parameters, in dependence on at least part of the primal parameters (see, e.g., Algorithm 1, Line 16 below). This process obtains updated primal parameters. The primal-space learned invertible operator is calculated separately for each primal patch.

At 1166, the computing means updates the reconstructed image based on the updated primal parameters (see, e.g., Algorithm 1, Line 19 below). In certain embodiments, both the first primal parameters and the second primal parameters contribute to the update of the reconstructed volume. For example, all the primal parameters that relate to a particular pixel may be combined (e.g. averaged with certain, potentially learnable weights), and that particular pixel of the reconstructed volume may be updated based on the combined value. For example, this may be achieved by a 1×1×1 convolution filter applied to the primal parameters. The updated reconstructed image may then be appended to an output list of reconstructed images, as discussed below.

The computing means performs the iterative process described by 1162, 1164 and 1166 a preconfigured number of times (the first plurality of iterations), for instance 6 times (see, e.g., Algorithm 1, Line 23 below). Intermediate reconstructed images may be stored as the iterative process is ongoing. For example, the updated reconstructions may be stored in a list. The list of reconstructions may contain all the reconstructions that are generated, one reconstruction for each iteration. Alternatively, e.g. when performing the reconstruction without an aim to train the learned operator, only the latest updated reconstruction is stored.

The channels may be permuted. The dual channels (which may be numbered 1 through N, wherein N is the number of dual channels) may be reordered according to a predetermined permutation. This permutation can be randomly determined. The permutation can be different for each iteration. However, preferably the permutation used in each iteration is set beforehand, that is: before training the learned operators; for instance, randomly chosen from the set of permutations that mix first and second half of the channels. Therefore, the permutations may be part of the system parameters θ.

Similarly, the primal channels (which may be numbered 1 through M, wherein M is the number of primal channels) may be reordered according to a predetermined permutation. This permutation can be randomly determined. The permutation can be different for each iteration. However, preferably the permutation used in each iteration is set beforehand, that is: before training the learned operators; for instance, randomly chosen from the set of permutations that mix first and second half of the channels. Therefore, the permutations may be part of the system parameters θ. In certain embodiments, where the number of primal channels equals the number of dual channels, the permutation of primal channels may be set equal to the permutation of dual channels for every time step. In some embodiments, channel permutation may be performed at the end of each iteration of steps 1162, 1164 and 1166.

At 118, the computing means processes the updated primal parameters, updated dual parameters, and updated reconstructed image to increase a resolution of the updated primal parameters, updated dual parameters, and updated reconstructed image by the first factor (see, e.g., Algorithm 1, Lines 24, 25 and 26). This may comprise increasing the resolution by the first factor, for example to return to 100% resolution. In further examples, if additional iterations at intermediate resolutions have been carried out, this may comprise increasing resolution by some other factor, such that the resolution is returned to 100%. The skilled reader will appreciate that the final resolution need not be exactly 100%; it is only necessary that the final resolution is increased relative to the reduced resolution. At 120, the computing means performs at least one additional iteration of steps 1162, 1164, 1166 at the increased resolution. The computing means may perform additional further iterations of steps 1162, 1164, 1166 at the increased resolution. For instance, when the number of scales or resolution is greater than two, the computing means repeats step 118 as well.

For example, the total number of iterations may be determined before or during algorithm training (e.g. 12 iterations), based on the desired inference speed and the image quality metrics on the validation set. Alternatively, for example if the primal/dual blocks are sharing the set of parameters starting from a certain iteration onwards, the iterations may continue until a data consistency error is below a certain threshold, or when the data consistency error does not decrease more than a certain threshold, from one iteration to the next iteration. In such a case, still a maximum number of iterations may be set. For example, the data consistency error can be calculated based on the reconstruction and the measured data.

At 122, the computing means outputs the updated reconstructed image (see, e.g., Algorithm 1, Line 29 below). After the last additional iteration, process ends and the computing means may return the reconstructed image that was stored in the last iteration, for example, or the reconstructed image associated with the smallest data consistency error may be returned. During training, a list or dataset containing all reconstructions may also be returned.

An implementation of the present disclosure (LIRE₊) may be given by function RECONSTRUCT (y, [symbol] , [symbol] , θ, V) as shown in Algorithm 1 below.

Algorithm 1: LIRE+

| 1: | procedure RECONSTRUCT(y, [symbol] , [symbol] , θ, V) | |
|---|---|---|
| 2: | α ← 50% | [symbol] Set resolution to 50% |
| 3: | y̅ ← ProjDown(y) | [symbol] Downsample & subsample projections |
| 4: | x̅ ← [symbol] (y̅) | [symbol] Normalized backprojection initialization |
| 5: | V̅ ← Downsample(V) | [symbol] Downsample FoV tensor |
| 6: | I ← [ ] | [symbol] Initialize output list |
| 7: | f ← x̅^{⊗8} ∈ X⁸ | [symbol] Initialize primal vector |
| 8: | h ← y̅^{⊗8} ∈ U⁸ | [symbol] Initialize dual vector |
| 9: | for i ← 1, . . . , 12 do | |
| 10: | d₁, d₂ ← Splt(h) | [symbol] Split dual channels |
| 11: | p₁, p₂ ← Splt(f) | [symbol] Split prime channels |
| 12: | pₒₚ ← [symbol] ([p₂, x̅]^{⊕}) | [symbol] Project p₂ and x̅ |
| 13: | d₂ ← d₂ + [symbol] ([pₒₚ, d₁, y̅]^{⊕}) | [symbol] Upd. d₂ |
| 14: | bₒₚ ← [symbol] (d₂) | [symbol] Backproject d₂ |
| 15: | LW ← [symbol] ( [symbol] (x̅) − y̅) | [symbol] Landweber term |
| 16: | p₂ ← p₂ + [symbol] ([bₒₚ, p₁, x̅, LW, V̅]^{⊕}) | [symbol] Upd. p₂ |
| 17: | h ← [d₁, d₂]^{⊕} | [symbol] Combine new dual |
| 18: | f ← [p₁, p₂]^{⊕} | [symbol] Combine new primal |
| 19: | x̅ ← x̅ + Conv3d(f, θᵢ^{o}) | [symbol] Update reconstruction |
| 20: | I ← I + [x̅] | [symbol] Append x̅ to output list |
| 21: | h ← Perm(h, θᵢ^{m}) | [symbol] Permute dual channels w. θᵢ^{m} |
| 22: | f ← Perm(f, θᵢ^{m}) | [symbol] Permute prim. channels w. θᵢ^{m} |
| 23: | if i == 6 then | |
| 24: | f, h ← Upsample(f), Upsample(h) | [symbol] Upsample latent vectors |
| 25: | x̅ ← Upsample(x̅) | [symbol] Upsample reconstruction |
| 26: | y̅, V̅, α ← y, V, 100% | [symbol] Switch to full resolution |

| | |
|---|---|
| 27: | end if |
| 28: | end for |
| 20: | return I |
| 30: | end procedure |

This example implementation of LIRE₊ comprises 12 iterations and uses primal/dual latent vectors with 8 channels. Here y is log-transformed and scaled projection data, [symbol] and [symbol] are normalized projection and backprojection operators respectively, θ is a list of parameters and V is an auxiliary Field-of-View tensor defined as

$$V ( p ) = \{ \begin{matrix}1 & p is seen from all projection angles \\ 0.5 & p is seen from half of the proj . angles \\ 0 & otherwise\end{matrix} .$$

It will be understood that the algorithm may be applied for any number of iterations. The number of parameters in each group may be varied accordingly. In fact, the number of iterations may be another parameter included in the parameter vector θ.

The parameters θ are partitioned into 4 parameter groups, where {θᵢ^{p}}ᵢ₌₁₂¹² are the primal block parameters, {θᵢ^{d}}ᵢ₌₁₂¹² are the dual block parameters, {θᵢ^{o}}ᵢ₌₁₂¹² are the output convolution parameters and {θᵢ^{m}}ᵢ₌₁₂¹² are the permutation parameters. For every i, the permutation θᵢ^{m} is some fixed permutation of [1, 2, . . . , 8] which is randomly initialized during model initialization and stored as a model parameter; one requires that om mixes the first and the second half of [1, 2, . . . , 8]. Channel-wise concatenation of tensors z₁, z₂, . . . , zₖ is denoted by [z₁, z₂, . . . , zₖ]^{⊕}, conversely, function Splt(z) splits tensor z with 2n channels into two halves along the channel dimension. Function Perm(z, ρ) permutes tensor z with n channels along the channel dimension with the permutation ρ∈Sym(n). Function Upsample(z) performs nearest upsampling of z to twice the resolution, Downsample(z) downsamples tensor z to half the resolution with linear interpolation and function ProjDown(z) downsamples projection tensor z to half the resolution and drops every second projection. For resolution α∈[50%, 100%], one writes [symbol] , [symbol] for the projection and backprojection operator respectively at a resolution, where for half resolution only every second projection from the original data is computed.

LIRE₊ uses a number of convolutional blocks. Conv3d(⋅, θᵢ^{o}) denotes a 1×1×1 convolution with parameters θᵢ^{o}. Γ_{θ}_{ᵢ}_{^{d}} denotes i-th dual block with parameters θᵢ^{p} comprised of 3 layers of 3×3×3 convolutions with 96, 96 and 4 filters respectively and LeakyReLU activation after the first and the second convolution layers. i-th primal block with parameters θᵢ^{p} is denoted by Δ_{θ}_{ᵢ}_{^{p}}, which is comprised of 3 layers of 3×3×3 P4-equivariant convolutions with 64, 64 and 4 filters respectively and LeakyReLU activation after the first and the second convolution layers. That is, input to a primal block has 8 channels and no ‘group dimension’, the first and the second convolution layers in a primal block return tensors with 64×4 channels (number of filters×group size), while output of the last convolution has 4×4 channels. This output is then averaged over the group dimension, making the primal block equivariant with respect to the action of P4 (i.e., 90-degree rotations along the z-axis). The present example uses centred weight normalization for the primal/dual block parameters to improve training stability.

Reversible residual primal-dual blocks and patch-wise computations inside the blocks, allow us to train using clinically-relevant resolutions and projection counts on current consumer hardware. The models may be trained on thorax CT scans and tested using both thorax CT and head & neck CT data.

The algorithm may be implemented as an extension of a machine learning library. Adjointness of the projection and backprojection operators can be tested by checking the definition of Hermitian adjoint

$$〈 𝒫 x , y 〉 = 〈 x , {𝒫}^{*} y 〉$$

for random positive test functions (tensors) x, y.

LIRE₊ training procedure may be identical to that of LIRE, wherein the loss function is a weighted sum of L¹ norm ∥⋅∥ and SSIM loss, taken separately over the full field of view region (i.e., voxels present in at least half of the projections) and the partial field of view region (i.e., voxels present in at least one projection). Mathematically,

$$L ( x , y ) = {‖ x - y ‖}_{FullFoV} + {α}_{1} \cdot ( 1. - {SSIM}_{FullFoV} ( x , y ) ) ++ {α}_{2} \cdot {‖ x - y ‖}_{PartFov} + {α}_{2} \cdot {α}_{1} \cdot ( 1. - {SSIM}_{PartFoV} ( x , y ) ) ,$$

In more detail, a procedure to calculate a loss function is shown in Algorithm 2:

Algorithm 2: loss calculation for LIRE+

| 01: procedure loss(x, y, V_{f}, Vₛ) | |
|---|---|
| 02: L₁ ←∥ x − y ∥ᵥ [symbol] | L¹ loss in full FOV |
| 03: L₂ ←∥ x − y ∥ᵥ [symbol] | L¹ loss in part. FOV |
| 04: S₁ ← 1.0 − SSIMᵥ [symbol] (x, y) | 1-SSIM, full FOV |
| 05: S₂ ← 1.0 − SSIMᵥ [symbol] (x, y) | 1-SSIM, part. FOV |

06: return L₁ + α₁S₁ + α₂(L₂ + α₁S₂)
07: end procedure [symbol]
indicates data missing or illegible when filed

Herein, SSIM denotes a structural similarity index and FOV denotes field of view.

Algorithm 3 provides a suitable training procedure. This example is supervised, and the training set (of e.g. CT volumes) is denoted by [symbol] ₜᵣₐᵢₙ.

Algorithm 3: training of LIRE+

01: procedure TRAIN( [symbol] ₜᵣₐᵢₙ, Nᵢₜₑᵣ)
02: set initial parameter settings θ
03: for j ← 1, ..., Nᵢₜₑᵣ do

| | |
|---|---|
| 04: x ~ [symbol] ₜᵣₐᵢₙ | Sample train volume |
| 05: Δ ~ [symbol] (0,100) ∈ [symbol] | Sample offset w.r.t. scan |
| | center |
| 06: δ ← x, spacing | Get spacing of volume x |
| 07: [symbol] , [symbol] * ← [symbol] [symbol] , [symbol] * [symbol] | Define projector, |
| | backprojector |
| 08: [symbol] , [symbol] * ← [symbol] /∥ [symbol] ∥, [symbol] * /∥ [symbol] ∥ | Normalize operators |
| 09: y ← Poisson(l [symbol] · e⁻ [symbol] ) | Noisy projections |
| 10: y̅ ← −ln(y)/∥ [symbol] ∥ | Normalized log-transform |
| 11: V_{f} ← FullFOV( [symbol] ) | Compute full FOV |
| 12: Vₚ ← PartialFOV( [symbol] ) | Compute partial FOV |
| 13: V [symbol] ← Vₚ\V_{f} | Incomplete FOV mask |
| 14: l ← RECONSTRUCT(y̅, [symbol] , [symbol] *, θ, V_{f}) | Reconstruct |
| 15: loss ← 0 | Initial loss tensor |
| 16: for z ← l[1], ..., l[8] do | Loop over iterates |
| 17: loss ← loss + LOSS(x, z, V_{f}, Vₛ) | Increment loss |

18: end for
19: compute gradients of loss w.r.t. θ
20: update θ
21: end for
22: end procedure [symbol]
indicates data missing or illegible when filed

In the above Algorithm 3, Nᵢₜₑᵣ is the number of iterations. In a certain embodiment of the training procedure, a CT volume is repeatedly sampled from the training dataset in Line 4 of Algorithm 3. During the sampling, augmentations that flip patient left-right and top-bottom are randomly applied, both with probability 50%. We sample a random offset for the rotation centre with respect to the centre of the CT volume from an isotropic Gaussian distribution with 0 mean and a standard deviation of 100 mm in Line 10. Choosing a random offset can be viewed as an additional type of augmentation, furthermore, in practice the isocenter in radiotherapy will be located close to a tumour. These augmentations are merely presented as examples. The training method is not limited by these augmentations of the training data.

We define projection [symbol] and backprojection [symbol] operators for the CBCT projection geometry with given volume spacing and center offset in Line 7 of Algorithm 3, and in Line 8 of Algorithm 3 we compute normalized versions of these operators. The operator norm may be estimated numerically using, for example, a power method with, for example, three iterations. Such a power method is known by itself from e.g. Boyd, D. W (The power method for Ip norms, Linear Algebra and its Applications 9, 95-101, 1974).

Synthetic noisy projection data is computed in Line 9 of Algorithm 3 to model the noisy CBCT data acquisition process. This noisy projection data is log-transformed and scaled in Line 10 of Algorithm 3. In general, for a realistic CBCT geometry the field of view does not necessarily contain the scanned object completely. When comparing reconstruction metrics it may also be important to compute these metrics inside an appropriately defined field of view only, since having a large part of the volume set to 0 outside the corresponding field of view would yield over-optimistic reconstruction metrics. We define the full field of view tensor V_{f} and the partial field of view tensor Vₚ in Lines 11 and 12 of Algorithm 3 respectively, both of these are scalar tensors having same dimensions as the volume that we want to reconstruct. For the projection geometry with small FOV setting, the full field of view tensor is constructed as

$${V}_{f} ( p ) = \{ \begin{matrix}1 & p is seen from all projection angles \\ 0 & otherwise\end{matrix}$$

while for the projection geometry with large FOV setting the full field of view tensor is constructed as

$${V}_{f} ( p ) = \{ \begin{matrix}1 & p is seen from all projection angles \\ 0.5 & p is seen from half of the proj . angles \\ 0 & otherwise\end{matrix} .$$

It will be understood that in alternative embodiments, the full field of view tensor V_{f} could be any monotonic function in the number of projection angles from which a pixel p is seen. We chose to use different values (1.0 and 0.5) above to mark the voxels seen from all the projection angles and the voxels which are seen from only half of the angles; however, we expect that the exact numerical values used in these masks are not important. For both small and large field of view settings, the partial field of view is defined as

$${V}_{p} ( p ) = \{ \begin{matrix}1 & p is seen from at least one angles \\ 0 & otherwise\end{matrix}$$

In particular, this definition of Vₚ implies that in the central axial plane all voxels are marked as ‘partially visible’. It will be understood that in alternative embodiments, the full field of view tensor Vₚ could be any monotonic function in the number of projection angles from which a pixel p is seen, wherein preferably Vₚ(p)>V_{f}(p).

In Line 13 of Algorithm 3, we define Vₛ as the tensor which equals 1 on the set of all voxels p subject to Vₚ(p)>0, V_{f}(p)=0, and zero elsewhere. In Line 14 of Algorithm 3, we call the main reconstruction procedure (e.g. procedure RECONSTRUCT of Algorithm 1), providing log-transformed normalized projection data, normalized versions of projection and backprojection operators, the collection of weights θ and the auxiliary tensor V_{f}·V_{f} helps the network to deal with the non-homogeneous nature of the reconstruction artifacts.

Algorithm 1 returns a list I=[x₁, x₂, . . . , x₁₂] of reconstructions where the first 6 elements have half the resolution and the last 6 elements have full resolution. Reconstruction losses for all x∈I are computed and summed (Line 17 of Algorithm 3), the ground truth is downsampled to compute the loss for the half-resolution reconstructions x₁, . . . , x₆. Loss computation may be performed using e.g. the procedure LOSS of Algorithm 2. We may sum losses over the full field of view region, where V_{f}>0, and the partial field of view region, where Vₛ>0. We compute the loss for partial field of view to ensure that the network can provide at least an approximate reconstruction in this region.

As a data augmentation strategy, the present example may randomly flip data along the left-right and the head-foot axes. Isocenter may be chosen by adding a random offset sampled from an isotropic Gaussian distribution with 0 mm mean and a standard deviation of 100 mm to the volume centre. As shown in Algorithm 2, a linear combination of L₁ loss and Structural Similarity Loss may be computed for both regions to calculate the loss function. In an example, α₁=0.5 and α₂ was set to 0.1 initially and then reduced to 0.01 after first learning rate decay step.

This example implementation of LIRE₊ was trained to reconstruct complete volumes. Two NVIDIA A100 GPUs with gradient accumulation were used with gradient accumulation enabled to achieve effective batch size of 8. Adam optimizer was employed with an initial learning rate of 0.001 and a plateau scheduler with linear warm-up and 10 epoch patience. At the end of each epoch models were evaluated, the best model was picked for testing. For the finetuning experiment on Head and Neck (HN) data, LIRE₊ was finetuned for 50 epochs with a quarter of the initial learning rate using a combined dataset of 8 HN CT volumes and 8 randomly chosen thorax CT volumes; best performing model on HN validation set was picked for the final testing on HN test data.

This following worked example simulates a common clinical acquisition geometry for a Linac-integrated CBCT scanner with a medium field-of-view setting, offset detector, a full 2π scanning trajectory and 720 projections. The source-isocenter distance is 1000 mm and the isocenter-detector plane distance is 536 mm. The detector is offset by 115 mm to the side in the direction of rotation to give an increased Field of View. Square detector panel with a side of 409.6 mm and 256×256 pixel array was used.

To train and evaluate an implementation of the present disclosure, here a thorax CT and head & neck CT data is used, consisting of a dataset of 424 thorax CT scans with isotropic spacing of 1 mm and a dataset of 79 head & neck CT scans with anisotropic spacing of between 0.9 mm and 1.0 mm for axial plane and between 1.0 mm and 1.6 mm for the perpendicular direction. Both datasets had axial slice of 512×512 voxels. All data is downsampled to 2 mm isotropic resolution, resulting in volumes with 2563 voxels. No denoising is applied to the CT scans, since unsupervised denoising could blur very fine details such as fissures leading to over-optimistic image quality metrics.

The thorax CT dataset is split into a training set of 260 scans, a validation set of 22 scans and a test set of 142 scans. The additional head & neck dataset is used in two regimes: for testing the models on out-of-distribution data and for additional finetuning experiment, where 79 volumes were randomly partitioned into a finetuning set of 8 volumes, 2 volumes for validation and 69 for testing (four outlier head & neck cases were used as test data). To simulate noisy projection data from the CT scans, Hounsfield units are converted into attenuation coefficients using a μ value of 0.2 cm⁻¹ as the water linear attenuation coefficient. Attenuated projection data is corrupted by Poisson noise with an I₀ value of 30000 photons.

A direct comparison with a known LIRE technique is provided, using the same dataset. Algorithm 4 below provides a known LIRE-based technique, for comparison purposes.

Algorithm 4: LIRE (known technique)

01: procedure RECONSTRUCT(y, [symbol] , [symbol] *, θ, V)

| | |
|---|---|
| 02: x₀ ← [symbol] * (y) | Normalized |
| | backprojector init |
| 03: l ← [ ] | Initialize output list |
| 04: f ← x₀^{⊗} [symbol] ∈ X [symbol] | Initialize primal vector |
| 05: h ← y^{⊗} [symbol] ∈ U [symbol] | Initialize dual vector |
| 06: for i ← 1, ...,8 do | |
| 07: d₁, d₂ ← Splt(h) | Split dual channels |
| 08: p₁, p₂ ← Splt(f) | Split prime channels |
| 09: pᵤₚ ← [symbol] ([p₂, xᵢ₋₁]^{⊕}) | Project p₂ and xᵢ₋₁ |
| 10: d₂ ← d₂ + Γ_{θ} [symbol] ([pₒₚ, d₁, y]^{⊕}) | Update d₂ |
| 11: bᵤₚ ← [symbol] * (d₂) | Backproject d₂ |
| 12: LW ← [symbol] * ( [symbol] (xᵢ₋₁) − y) | Landweber term |
| 13: p₂ ← p₂ + Λ_{θ} [symbol] ([bₒₚ, pᵢ, xᵢ₋₁, LW, V]^{⊕}) | Update p₂ |
| 14: h ← [d₁, d₂]^{⊕} | Combine new dual |
| 15: f ← [p₁, p₂]^{⊕} | Combine new primal |
| 16: xᵢ ← xᵢ₋₁ + Conv3d(f, θᵢ^{o}) | Update xᵢ₋₁ |
| 17: l ← l + [xᵢ] | Append xᵢ to output list |
| 18: h ← Perm(h, θᵢ^{m}) | Permute dual channels |
| | w, θᵢ^{m} |
| 19: f ← Perm(f, θᵢ^{m}) | Permute prime channels |
| | w, θᵢ^{m} |

20: end for
21: return l
22: end procedure [symbol]
indicates data missing or illegible when filed

The process of computing the gradients for the neural network coefficients involves reversing the forward pass and using invertibility of the architecture to re-compute previous values of primal/dual parameters (f and g in Algorithms 4 and 1) starting from the last values obtained during the forward pass. The restored primal/dual parameters can then be used to re-compute intermediate activations inside the primal/dual blocks (one block at a time) which are necessary for the gradient computations for network coefficients via backpropagation. Apart from the memory optimizations, this gradient computation procedure may be mathematically equivalent to the standard backpropagation and may yield identical gradients.

To exemplify in the particular setting of Algorithms 4 and 1, we first reverse the primal/dual channel permutations together with the corresponding gradient data in Lines 18 and 19 in Algorithm 4 (Lines 21 and 22 in Algorithm 1). Continuing with Algorithm 4 for example, for i=8, we take the gradient of the primal/dual vectors to be zero, while for i=7, 6, . . . , 1, the corresponding gradients are computed in the preceding step i+1. The last reconstruction update x₈←x₇+Conv3d (f, θ₈⁰) in Line 16 in Algorithm 4 provides gradients to the network coefficients θ₈⁰ as well as additional gradients for the primal vector f and x₇. The primal vector f together with the gradient data is split into p₁, p₂ and the dual vector d together with the gradient data is split into d₁, d₂, reversing the concatenation performed in Lines 14, 15. To compute the gradients for the coefficients θ₈⁰ in the primal p₂ update operation in Line 13, it is sufficient to know the gradient for p₂ and the input tensor [bₒₚ, p₁, x₇, LW, V]^{⊕}. This input tensor is provided to the primal update block Λ₇₄ _{₈}_{^{p}} patch-by-patch, the intermediate activations are re-computed separately for each patch and the gradient computation is performed via standard backpropagation separately on each patch by taking the corresponding patch of the gradient tensor for p₂ for each patch of the input tensor.

The gradients of the coefficients θ₈^{p} are aggregated via summation of the coefficient gradients computed on patches. For the input tensor gradient, we first allocate a zero tensor having the same shape as the input tensor [bₒₚ, p₁, x₇, LW, V]^{⊕} to store this gradient, and subsequently, for each patch of the input tensor, add the resulting input gradients to the corresponding spatial region of this zero-initialized gradient tensor. As a result, this yields gradients to the coefficients θ₈^{p} and the tensors bₒₚ, LW, as well as additional gradients to the tensors p₁, x₇. Furthermore, knowing Λθ₈^{p} ([bₒₚ, p₁, x₇, LW, V]^{⊕}) and the last value of p₂ allows to restore the original value of p₂ in Line 13 patch-by-patch and erase the latest value of p₂ from the memory.

After that, Lines 11-12 contain differentiable operations, and provide gradients to d₂ as well as additional gradient for x₇. To compute the gradients for the coefficients θ₈^{d} in the dual update operation in Line 10, it suffices to know the gradient for d₂ 2 and the input tensor [pₒₚ, d₁, y]^{⊕}. The gradient computation is performed similarly to the primal update, this provides gradients to the coefficients θ₈^{d} and the tensors pₒₚ as well as additional gradient for d₁. Furthermore, this allows one to restore the original value of d₂ in Line 10 and erase the latest value of d₂ from the memory. Line 9 contains differentiable operation, and 10 provides additional gradient to x₇ as well as gradient for the “restored” p₂. The parts p₁, p₂ and d₁, d₂ together with the corresponding gradients are combined back into primal and dual vectors together with the corresponding gradients, reversing the split in Lines 7 and 8. After this, the gradient computation proceeds similarly for i=7, 6, . . . , 1.

The skilled reader will appreciate that the above description for the LIRE algorithm (Algorithm 4) is equally applicable to the LIRE₊ algorithm (Algorithm 1) provided above, for instance since the upsampling operation in step 118 is differentiable.

To add further context to this comparison, the following baselines are also provided: FBP (see the work of L. A. Feldkamp, L. C. Davis, and J. W. Kress (Practical cone-beam algorithm, J. Opt. Soc. Am. A 1, 612-619, 1984)), PDHG with Total Variation (TV) regularisation (see the work of A. Chambolle and T. Pock, A First-Order Primal-Dual Algorithm for Convex Problems with Applications to Imaging, J. Math. Imaging Vis. 40, 120-145, 2011)), U-net (see the work of Ö. Çiçek, et al. (3D U-Net: Learning Dense Volumetric Segmentation from Sparse Annotation, in Medical Image Computing and Computer-Assisted Intervention—MICCAI 2016, 424-432, 2016)), and Uformer with FBP input (see the work of Z. Wang, et al. (Uformer: A General U-Shaped Transformer for Image Restoration, in Proceedings of the IEEE/CVF Conference on Computer Vision and Pattern Recognition (CVPR), 17683-17693 (2022)), as well as LIRE itself. An additional baseline is ∂U-Net (see the work of A. Hauptmann, et al. (Multi-Scale Learned Iterative Reconstruction, IEEE Transactions on Computational Imaging 6, 843-856, 2020)), which plays the role of an alternative memory efficient and fast learned iterative scheme. The implementation of ∂U-Net herein relies on the open-source implementation from the author, where the base filter count was increased from 12 to 32 in order to get closer to the filter counts used by LIRE and LIRE₊ to make the comparison fair but fit into memory budget. Batch normalization is switched to instance normalization in this version of ∂U-Net, since batch normalization resulted in unstable convergence, presumably, because of very small batch size. As input to ∂U-net, the present example provided the FBP reconstruction and the field-of-view tensor V defined above. The same augmentation strategy as LIRE₊ and the same loss function (see above) are used. To train ∂U-net, Adam optimizer is employed with batch size of 8 on two NVIDIA Quadro RTX 8000 cards via gradient accumulation, initial learning rate of 0.0001 and a plateau scheduler with linear warm-up and 10 epoch patience. The best performing model on the validation set is chosen for testing. For the finetuning experiment on HN data, the corresponding pretrained ∂U-net or LIRE model is taken and finetuned for 50 epochs with a quarter of the initial learning rate using a combined dataset of 8 HN CT volumes and 8 randomly chosen thorax CT volumes; best performing model on HN validation set is picked for the final testing on HN test data.

For the internal patch-based computations inside LIRE₊, the present example sets the patch size to 128×128× 128, resulting in roughly 30 GB VRAM usage per single volume during training. Reducing the patch size to 32×32×32 and enabling CPU-GPU streaming decreases the usage to roughly 12 GB VRAM per single volume. For ∂U-net, GPU memory usage during training is around 48 GB per volume.

The total parameter counts are: 24M parameters for LIRE, 7M for LIRE₊ with 9 iterations, 9M for LIRE₊ with 12 iterations and 27M for ∂U-net. The following per-volume inference times are measured on NVIDIA A100 accelerator: 31 seconds for LIRE, 32 seconds for LIRE₊ with 12 iterations, 17 seconds for LIRE₊ with 9 iterations and 4 seconds for ∂U-net.

Extensive evaluation of LIRE₊ according to the present disclosure and the baselines are performed using image quality metrics such as PSNR and SSIM, which are computed for the reconstructed and the ground truth attenuation values, as well as MAE in Hounsfield Units. MAE is computed at 2 mm resolution as well as at the reduced resolution of 4 mm, where both the ground truth and the reconstruction are binned. The additional MAE computation on downsampled data is designed to provide more insight about HU calibration for radiotherapy applications, since the ‘ground truth’ CT scans are not denoised and thus remain quite noisy as can be seen from the difference maps (see FIGS. 5 and 7).

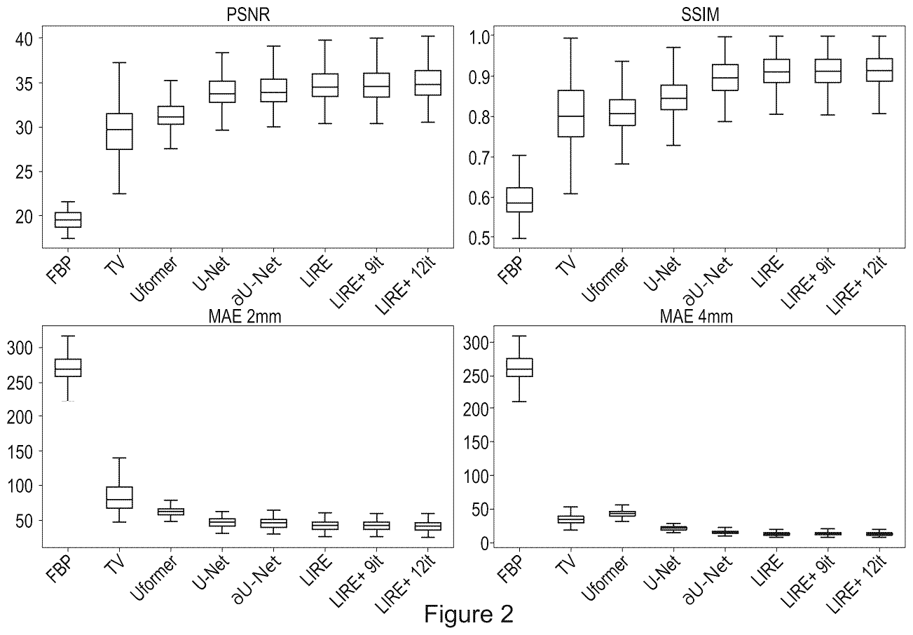

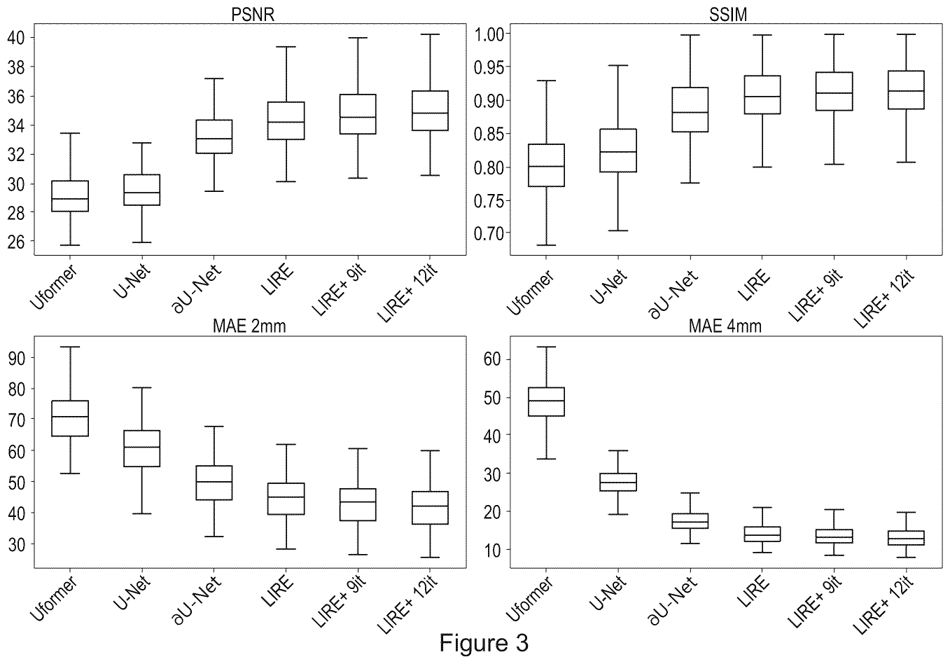

Tables 1 and 2 below report these metrics on thorax CT data for straight and rotated patient orientation respectively, and the corresponding box plots are provided in FIGS. 2 and 3. Since the classical reconstruction methods such as FBP and TV are not trained on specific patient orientation, they are robust to rotations by design and are omitted in the second comparison. On the straight data (FIG. 2), one may observe that LIRE and LIRE₊ noticeably outperform all the baselines. LIRE₊ (according to the present disclosure) is able to achieve LIRE level of performance using only 9 iterations out of 12. Full version of LIRE₊ with 12 iterations gives a small performance improvement over LIRE. ∂U-net, while being fast, cannot match the reconstruction quality achieved by LIRE/LIRE₊, even though it has more parameters. On the rotated data (FIG. 3), we note that only LIRE₊ is able to maintain the reconstruction quality thanks to the rotationally-equivariant primal cells, while all alternative models suffer from various amounts of performance degradation. It is worthwhile to note that the performance degradation is more pronounced in the learned post-processing baselines (Uformer and U-net), while learned iterative schemes seem to be more robust.

TABLE 1
Test results on thorax CT (best result
in bold, bottom row), mean ± std. dev.

| | | | MAE 2 | MAE 4 |
|---|---|---|---|---|
| Method | PSNR | SSIM | mm (HU) | mm (HU) |
| FBP | 20.05 ± 2.30 | 0.66 ± 0.07 | 270.70 ± 19.78 | 261.29 ± 21.36 |
| TV | 29.23 ± 2.87 | 0.79 ± 0.09 | 85.07 ± 24.10 | 35.26 ± 8.32 |
| Uformer | 31.62 ± 2.44 | 0.81 ± 0.06 | 62.91 ± 7.44 | 43.66 ± 5.74 |
| U-Net | 34.29 ± 2.71 | 0.84 ± 0.06 | 47.86 ± 7.34 | 21.70 ± 3.56 |
| ∂U-Net | 34.55 ± 2.72 | 0.90 ± 0.05 | 46.14 ± 7.01 | 15.71 ± 2.71 |
| LIRE | 35.14 ± 2.76 | 0.91 ± 0.04 | 43.02 ± 6.88 | 13.20 ± 2.64 |
| LIRE+ | 35.15 ± 2.79 | 0.91 ± 0.05 | 42.89 ± 6.99 | 13.58 ± 2.66 |
| 9 it. | | | | |
| LIRE+ | 35.38 ± 2.82 | 0.91 ± 0.04 | 41.86 ± 7.01 | 13.11 ± 2.64 |
| 12 it. | | | | |

TABLE 2
Test results on rotated thorax CT (best result
in bold, bottom row), mean ± std. dev.

| | | | MAE 2 | MAE 4 |
|---|---|---|---|---|
| Method | PSNR | SSIM | mm (HU) | mm (HU) |
| Uformer | 29.53 ± 2.58 | 0.80 ± 0.06 | 70.70 ± 8.83 | 49.06 ± 6.64 |
| U-Net | 29.98 ± 2.62 | 0.83 ± 0.06 | 60.48 ± 8.55 | 27.99 ± 3.73 |
| ∂U-Net | 33.64 ± 2.66 | 0.89 ± 0.05 | 49.65 ± 6.95 | 17.50 ± 2.82 |
| LIRE | 34.71 ± 2.72 | 0.91 ± 0.05 | 44.60 ± 6.85 | 14.17 ± 2.78 |
| LIRE+ 9 it. | 35.15 ± 2.79 | 0.91 ± 0.05 | 42.89 ± 6.99 | 13.58 ± 2.66 |
| LIRE+ 12 it. | 35.38 ± 2.82 | 0.91 ± 0.04 | 41.86 ± 7.01 | 13.12 ± 2.64 |

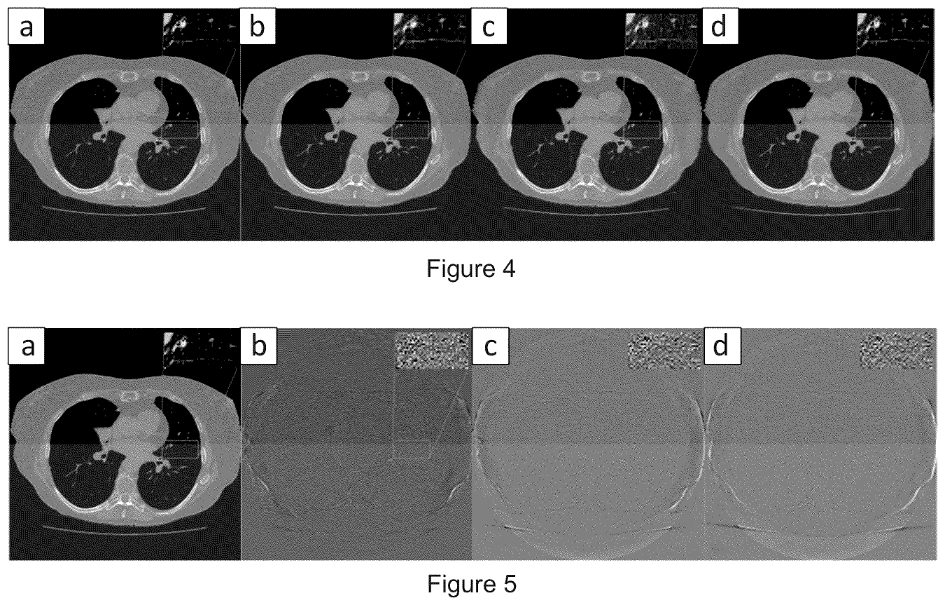

Examples of axial image slices of a ground truth image and the corresponding reconstructions with ∂U-net, LIRE and LIRE₊ are presented in FIG. 4 with the respective difference maps in FIG. 5. FIG. 4, panel (a) shows an axial slice of Thorax CT, HU range=(−1000, 800) and (−1350, 150) for ROI. Panel (b) provides a comparative example with ∂U-net, panel (c) with LIRE, and panel (d) with LIRE₊ 12 it (that is, using techniques according to the present disclosure).

FIG. 5, panel (a) shows an axial slice of Thorax CT, panel (b) shows ∂U-net error, HU range=(−1000, 800) and (−200, 200) for ROI, panel (c) shows LIRE error, and panel (d) LIRE₊ 12 it. error.

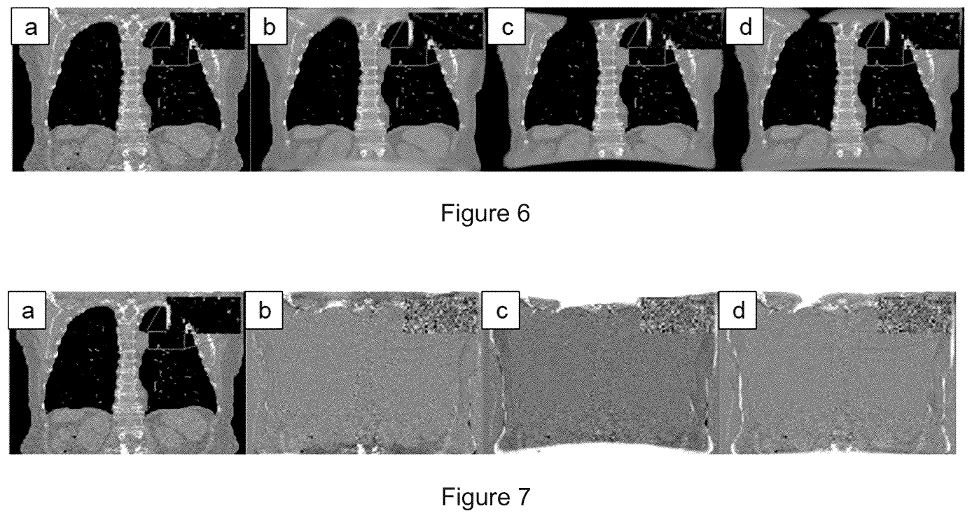

Coronal view is provided in FIG. 6 and FIG. 7. FIG. 6, panel (a) shows a coronal slice of Thorax CT, HU range=(−1000, 800) and (−1350, 150) for ROI. Panel (b) provides a comparative example with ∂U-net, panel (c) with LIRE, and panel (d) with LIRE₊ 12 it. FIG. 7, panel (a) shows a coronal slice of Thorax CT, panel (b) shows ∂U-net error, HU range=(−1000, 800) and (−200, 200) for ROI, panel (c) shows LIRE error, and panel (d) LIRE₊ 12 it. error.

For the image samples the HU range equals (−1000, 800) and (−1350, 150) for the ROI, while for the difference maps HU range equals (−1000, 800) and (−200, 200) for the ROI. From these examples we can see that LIRE₊ gives sharper images with better HU calibration, while au-net appears to slightly blur lung fissures. The difference maps suggest that particularly for LIRE₊ image noise plays a large role in the image quality metrics.

As another comparative example, evaluation on the out-of-distribution Head and Neck (HN) dataset is performed in two regimes. Firstly, the reconstruction performance of LIRE₊, LIRE and ∂U-net without any finetuning is provided the metrics in Table x below (in non-italicised font, on the top row of each method). Inspection of the metrics and the images reveals that there are 4 outlier cases on which LIRE₊ performs poorly (corresponding to very large or very small patients), while on the majority of cases LIRE₊ is comparable to LIRE. Reconstruction metrics on the HN set with the outlier cases excluded are provided in Table 3 in italic font (the bottom row for each method), indicating that LIRE₊ might actually outperform LIRE on a majority of HN cases. For comparison, iterative reconstruction baseline is provided as well.

TABLE 3
Test results on Head & Neck CT without finetuning, mean ± std. dev. Results
on test excluding the outliers given in italic (bottom row for each method).

| Method | PSNR | SSIM | MAE 2 mm (HU) | MAE 4 mm (HU) |
|---|---|---|---|---|
| TV | 37.86 ± 1.36 | 0.94 ± 0.02 | 30.72 ± 5.63 | 15.48 ± 3.20 |
| | 37.92 ± 1.33 | 0.94 ± 0.02 | 30.46 ± 5.37 | 15.25 ± 2.74 |
| ∂U-Net | 40.24 ± 1.57 | 0.97 ± 0.01 | 17.81 ± 4.33 | 9.20 ± 2.51 |
| | 40.47 ± 1.18 | 0.98 ± 0.01 | 17.00 ± 2.11 | 8.74 ± 1.31 |
| LIRE | 41.21 ± 1.41 | 0.97 ± 0.01 | 17.75 ± 2.90 | 10.33 ± 1.57 |
| | 41.43 ± 1.22 | 0.97 ± 0.01 | 17.23 ± 1.87 | 10.07 ± 1.08 |
| LIRE+ 9 it. | 39.66 ± 9.52 | 0.95 ± 0.15 | 203.32 ± 1028.00 | 245.77 ± 1288.28 |
| | 41.78 ± 1.66 | 0.98 ± 0.01 | 15.68 ± 2.68 | 7.81 ± 1.27 |
| LIRE+ 12 it. | 40.52 ± 8.66 | 0.95 ± 0.15 | 119.90 ± 548.44 | 139.62 ± 675.60 |
| | 42.45 ± 1.76 | 0.98 ± 0.01 | 14.09 ± 2.82 | 6.96 ± 1.51 |

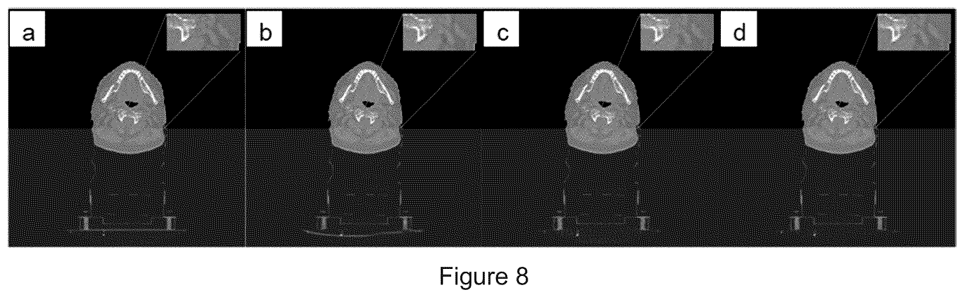

Secondly, to further investigate the generalization behaviour of LIRE₊, the results of the finetuning experiment are reported in Table 4. Interestingly, after identical finetuning, both full LIRE₊ and LIRE₊ with only 9 iterations demonstrate substantially better performance compared to LIRE and ∂U-net. The better generalization of LIRE₊ after finetuning on a limited amount of data is in agreement with the lower parameter count of the new model. Axial image slices from finetuned HN models are provided in FIG. 8, where HU range is set to (−1000, 1000). Panel (a) shows an axial slice of HN CT, HU range=(−1000, 1000). Panel (b) provides a comparative example with ∂U-net, panel (c) with LIRE, and panel (d) with LIRE₊ 12 it.

TABLE 4
Test results on Head & Neck CT with finetuning (best
result in bold, bottom row), mean ± std. dev.

| | | | MAE 2 | MAE 4 |
|---|---|---|---|---|
| Method | PSNR | SSIM | mm (HU) | mm (HU) |
| ∂U-Net | 41.57 ± 1.33 | 0.98 ± 0.01 | 14.72 ± 2.87 | 7.31 ± 1.80 |
| LIRE | 42.76 ± 1.52 | 0.99 ± 0.01 | 13.02 ± 2.14 | 5.77 ± 1.00 |
| LIRE+ 9 it. | 43.17 ± 1.83 | 0.99 ± 0.01 | 12.54 ± 2.25 | 5.34 ± 1.01 |
| LIRE+ 12 it. | 43.82 ± 1.93 | 0.99 ± 0.01 | 11.50 ± 2.21 | 4.82 ± 1.02 |

To summarise, LIRE₊ provides a fast, compact and memory-efficient multiscale equivariant learned iterative scheme for CBCT reconstruction. Compared to LIRE, LIRE₊ has substantially lower parameter count, similar inference time for better image quality or twice faster inference for similar image quality, and enjoys additional robustness to patient orientation, which may be achieved by using rotationally-equivariant primal blocks. It is noteworthy that LIRE₊ is the smallest deep learning reconstruction model in the above comparative example, but it still gives the best image quality. On the out-of-distribution head & neck dataset, one may observe that LIRE₊ is generally comparable to LIRE but has some outlier cases. However, after identical finetuning on a limited amount of head & neck data, LIRE₊ strongly outperforms LIRE and ∂U-net.

The present disclosure provides a rotationally-equivariant multiscale learned invertible primal/dual iterative scheme for CBCT reconstruction. Memory usage is optimized by relying on simple reversible residual networks in primal/dual cells and patch-wise computations inside the cells during forward and backward passes, while increased inference speed is achieved by making the primal-dual scheme multiscale so that the reconstruction process starts at low resolution and with low resolution primal/dual latent vectors. Transitions to higher resolutions are performed with nearest upsampling operations, whose injectivity allows to reverse the operation unambiguously during the backward pass. Rotational equivariance is accomplished with group equivariant convolutions inside the primal cells.

Multiscale reconstruction can be naturally integrated into invertible learned primal-dual scheme and can accelerate CBCT reconstruction without loss of image quality. Rotational equivariance in a learned primal-dual iterative scheme can be enforced by making the primal components of the network rotationally equivariant.

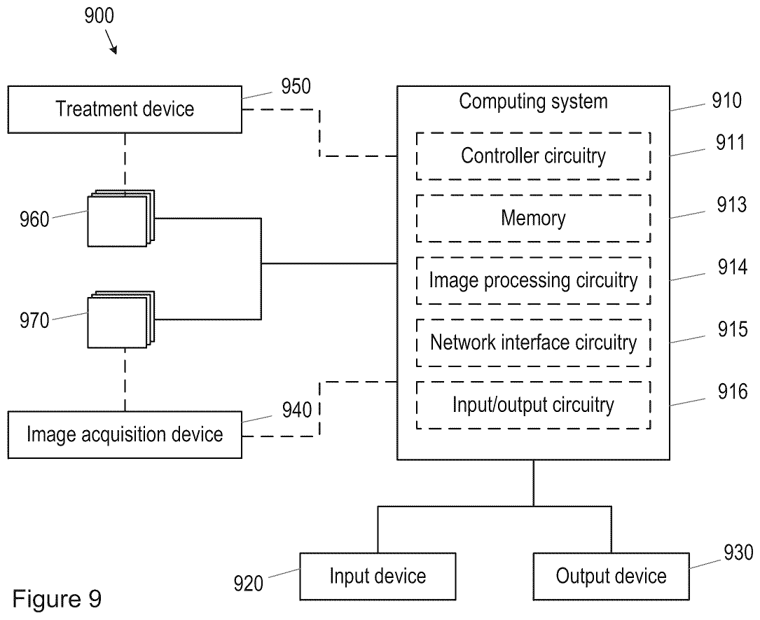

FIG. 9 is a block diagram of an implementation of a radiotherapy treatment system 900, suitable for executing methods for image reconstruction using a learned iterative scheme according to embodiments. The example radiotherapy system 900 comprises a computing system 910 within which a set of instructions, for causing the computing system 910 to perform the method (or steps thereof) discussed herein, may be executed. The computing system 910 may implement an image reconstruction system. The computing system 910 may also be referred to as a computer or computing means. In particular, the methods described herein may be implemented by a processor or controller circuitry 911 of the treatment planning system 910.

The computing system 910 shall be taken to include any number or collection of machines, e.g., computing device(s), that individually or jointly execute a set (or multiple sets) of instructions to perform any one or more of the methods discussed herein. That is, hardware and/or software may be provided in a single computing device, or distributed across a plurality of computing devices in the computing system. In some implementations, one or more elements of the computing system may be connected (e.g., networked) to other machines, for example in a Local Area Network (LAN), an intranet, an extranet, or the Internet. One or more elements of the computing system may operate in the capacity of a server or a client machine in a client-server network environment, or as a peer machine in a peer-to-peer (or distributed) network environment. One or more elements of the computing system may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine.

The computing system 910 includes controller circuitry 911 and a memory 913 (e.g., read-only memory (ROM), flash memory, dynamic random access memory (DRAM) such as synchronous DRAM (SDRAM) or Rambus DRAM (RDRAM), etc.). The memory 913 may comprise a static memory (e.g., flash memory, static random access memory (SRAM), etc.), and/or a secondary memory (e.g., a data storage device), which communicate with each other via a bus (not shown). Memory 913 may be used to store or buffer measured data and parameters until required for image reconstruction.

Controller circuitry 911 represents one or more general-purpose processors such as a microprocessor, central processing unit, accelerated processing units, or the like. More particularly, the controller circuitry 911 may comprise a complex instruction set computing (CISC) microprocessor, reduced instruction set computing (RISC) microprocessor, very long instruction word (VLIW) microprocessor, processor implementing other instruction sets, or processors implementing a combination of instruction sets. Controller circuitry 911 may also include one or more special-purpose processing devices such as an application specific integrated circuit (ASIC), a field programmable gate array (FPGA), a digital signal processor (DSP), network processor, or the like. One or more processors of the controller circuitry may have a multicore design. Controller circuitry 911 is configured to execute the processing logic for performing the operations and steps discussed herein.

The computing system 910 may further include a network interface circuitry 915. The computing system 910 may be communicatively coupled to an input device 920 and/or an output device 930, via input/output circuitry 916. In some implementations, the input device 920 and/or the output device 930 may be elements of the computing system 910. The input device 920 may include an alphanumeric input device (e.g., a keyboard or touchscreen), a cursor control device (e.g., a mouse or touchscreen), an audio device such as a microphone, and/or a haptic input device. The output device 930 may include an audio device such as a speaker, a video display unit (e.g., a liquid crystal display (LCD) or a cathode ray tube (CRT)), and/or a haptic output device. In some implementations, the input device 920 and the output device 930 may be provided as a single device, or as separate devices.

In some implementations, the computing system 910 may comprise image processing circuitry 914. Image processing circuitry 914 may be configured to process measured data 970 (e.g., images, imaging data, projections, projection data), such as projection data obtained from one or more imaging data sources, a treatment device 950 and/or an image acquisition device 940. Image processing circuitry 914 may be configured to process, or pre-process, measured data 970. For example, image processing circuitry 914 may convert received data into a particular format, size, resolution or the like. Image processing circuitry 914 may be configured to perform image reconstruction. In some implementations, image processing circuitry 914 may be combined with controller circuitry 911.

In some implementations, the radiotherapy system 900 may further comprise an image acquisition device or apparatus 940 and/or a treatment device or apparatus 950. The image acquisition device 940 and the treatment device 950 may be provided as a single device. In some implementations, treatment device 950 is configured to perform imaging, for example in addition to providing treatment and/or during treatment.

Image acquisition device 940 may be configured to perform positron emission tomography (PET), computed tomography (CT), magnetic resonance imaging (MRI), single positron emission computed tomography (SPECT), X-ray, and the like.

Image acquisition device 940 may be configured to output measured data 970, which may be accessed by computing system 910. Treatment device 950 may be configured to output treatment data 960, which may be accessed by computing system 910. Treatment data 960 may be obtained from an internal data source (e.g., from memory 913) or from an external data source, such as treatment device 950 or an external database.

The various methods described above may be implemented by a computer program. The computer program may include computer code (e.g., instructions) arranged to instruct a computer to perform the functions of one or more of the various methods described above. For example, the steps of the methods described in relation to FIG. 1 may be performed by the computer code. The steps of the methods described above may be performed in any suitable order. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid state memory, magnetic tape, a removable computer diskette, a random access memory (RAM), a read-only memory (ROM), a rigid magnetic disc, and an optical disk, such as a CD-ROM, CD-R/W or DVD. The instructions may also reside, completely or at least partially, within the memory 913 and/or within the controller circuitry 911 during execution thereof by the computing system 910, the memory 913 and the controller circuitry 911 also constituting computer-readable storage media.

In an implementation, the modules, components and other features described herein may be implemented as discrete components or integrated in the functionality of hardware components such as ASICS, FPGAs, DSPs or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may comprise a special-purpose processor, such as an FPGA or an ASIC. A hardware component may also include programmable logic or circuitry that is temporarily configured by software to perform certain operations.

In addition, the modules and components may be implemented as firmware or functional circuitry within hardware devices. Further, the modules and components may be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “receiving”, “determining”, “comparing”, “enabling”, “maintaining”, “identifying”, “obtaining”, “accessing”, or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

While certain embodiments have been described, these embodiments have been presented by way of example only, and are not intended to limit the scope of the present disclosure. Indeed, the novel methods and apparatuses described herein may be embodied in a variety of other forms; furthermore, various omissions, substitutions and changes in the form of methods and apparatus described herein may be made.

What is claimed is:

1. A computer implemented method for image reconstruction using a learned iterative scheme, the method comprising:
obtaining measured data defined in a dual space, the measured data relating to a primal space;
processing the measured data to reduce a resolution of the measured data by a first factor;
initiating a reconstructed image in the primal space based on the processed measured data;
determining dual parameters defined in the dual space based on the processed measured data;
determining primal parameters defined in the primal space based on the initiated reconstructed image;
identifying a plurality of primal patches, each primal patch representing a subvolume of the primal space, wherein the primal space is divided into the plurality of the primal patches;
identifying a plurality of dual patches, each dual patch representing a subset of the dual space, wherein the dual space is divided into the plurality of the dual patches;
iteratively updating the reconstructed image by iteration of:
a. applying a dual-space learned invertible operator to the dual parameters, in dependence on at least part of the dual parameters, to obtain updated dual parameters, wherein the dual-space learned invertible operator is calculated separately for each dual patch;
b. applying a primal-space learned invertible operator to the primal parameters, in dependence on at least part of the primal parameters, to obtain updated primal parameters, wherein the primal-space learned invertible operator is calculated separately for each primal patch;
c. updating the reconstructed image based on the updated primal parameters; and
outputting the updated reconstructed image;
wherein iteratively updating the reconstructed image comprises:
performing a first plurality of iterations of steps a., b., and c.;
processing the updated primal parameters, updated dual parameters, and updated reconstructed image to increase a resolution of the updated primal parameters, updated dual parameters, and updated reconstructed image; and
performing at least one additional iteration of steps a., b., and c.

2. The method of claim 1, wherein each of the dual-space learned invertible operator and primal-space learned invertible operator comprises a convolutional neural network, and wherein the primal-space learned invertible operator comprises an equivariant convolutional neural network.

3. The method of claim 1, wherein processing the measured data to reduce a resolution of the measured data by a first factor comprises:
downsampling the measured data to a resolution reduced by the first factor.

4. The method of claim 1, wherein processing the measured data to reduce a resolution of the measured data by a first factor comprises:
subsampling the measured data by a parameter that is determined by the first factor.

5. The method of claim 1, wherein processing the updated primal parameters, updated dual parameters, and updated reconstructed image to increase a resolution of the updated primal parameters, updated dual parameters, and updated reconstructed image, comprises:
performing an injective process on the updated primal parameters, updated dual parameters, and updated reconstructed image.

6. The method of claim 1, wherein processing the updated primal parameters, updated dual parameters, and updated reconstructed image to increase a resolution of the updated primal parameters, updated dual parameters, and updated reconstructed image, comprises:
performing a nearest upsampling operation.

7. The method of claim 1, wherein initiating a reconstructed image in the primal space based on the processed measured data comprises performing at least one of:
a backprojection reconstruction technique; and
an iterative reconstruction technique.

8. The method of claim 1, wherein iteratively updating the reconstructed image further comprises:
calculating auxiliary dual parameters based on at least part of the primal parameters, wherein the dual space learned invertible operator is further dependent on the auxiliary dual parameters; and
calculating auxiliary primal parameters based on at least part of the dual parameters, wherein the primal space learned invertible operator is further dependent on the auxiliary primal parameters.

9. The method of claim 8, wherein calculating the auxiliary dual parameters comprises forward-projecting at least part of the primal parameters, and calculating the auxiliary primal parameters comprises back-projecting at least part of the dual parameters.

10. The method of claim 9, wherein, for the first plurality of iterations, forward-projecting at least part of the primal parameters, and back-projecting at least part of the dual parameters, comprises computing a projection or back-projection for a subset of the measured data, the subset being determined by the first factor.

11. The method of claim 9, wherein calculating the auxiliary dual parameters further comprises forward-projecting the updated reconstructed image in the primal space; and wherein the primal-space learned invertible operator is further dependent on the updated image.

12. The method of claim 11, further comprising:
organizing the dual parameters in a plurality of dual channels, each dual channel corresponding to the dual space, and dividing the dual channels into first dual channels containing first dual parameters and second dual channels containing second dual parameters; and
organizing the primal parameters in a plurality of primal channels, each primal channel corresponding to the primal space, and dividing the primal channels into first primal channels containing first primal parameters and second primal channels containing second primal parameters.

13. The method of claim 12, wherein applying the dual-space learned invertible operator to the dual parameters comprises updating the second dual parameters based on an output of a dual-space learned model without changing the first dual parameters, wherein the output of the dual-space learned model is calculated separately for each dual patch, and wherein the applying the primal-space learned invertible operator to the primal parameters comprises updating the second primal parameters based on an output of a primal-space learned model without changing the first primal parameters, wherein the output of the primal-space learned model is calculated separately for each primal patch.

14. The method of claim 12, wherein calculating the auxiliary dual parameters comprises forward-projecting the second primal parameters, and calculating the auxiliary primal parameters comprises back-projecting the second dual parameters.

15. The method of claim 12, further comprising:
permuting the dual channels to mix the first dual channels and the second dual channels; and
permuting the primal channels to mix the first primal channels and the second primal channels.

16. The method of claim 1, further comprising:
calculating an error term based on the updated reconstructed image in the primal space and the processed measured data defined in the dual space, and wherein at least one of the primal-space learned invertible operator and the dual-space learned invertible operator is dependent on the error term.

17. The method of claim 2, further comprising applying weight normalization to parameters of the primal-space learned invertible operator and the dual-space learned invertible operator.

18. The method of claim 1, wherein the plurality of patches overlap each other.

19. The method of claim 1, wherein the subset of the dual space comprises a rectangular area of a projection.

20. The method of claim 1, wherein the measured data comprise cone-beam X-ray projection data.

21. The method of claim 1, further comprising:
training the dual-space learned invertible operator and the primal-space learned invertible operator, based on a training dataset.

22. A non-transitory computer readable medium, with instructions stored thereon, which when executed by a processor of a computing device, cause the processor to:
obtain measured data defined in a dual space, the measured data relating to a primal space;
process the measured data to reduce a resolution of the measured data by a first factor;
initiate a reconstructed image in the primal space based on the processed measured data;
determine dual parameters defined in the dual space based on the processed measured data;
determine primal parameters defined in the primal space based on the initiated reconstructed image;
identify a plurality of primal patches, each primal patch representing a subvolume of the primal space, wherein the primal space is divided into the plurality of the primal patches;
identify a plurality of dual patches, each dual patch representing a subset of the dual space, wherein the dual space is divided into the plurality of the dual patches;
iteratively update the reconstructed image by iteration of:
a. applying a dual-space learned invertible operator to the dual parameters, in dependence on at least part of the dual parameters, to obtain updated dual parameters, wherein the dual-space learned invertible operator is calculated separately for each dual patch;
b. applying a primal-space learned invertible operator to the primal parameters, in dependence on at least part of the primal parameters, to obtain updated primal parameters, wherein the primal-space learned invertible operator is calculated separately for each primal patch;
c. updating the reconstructed image based on the updated primal parameters; and
outputting the updated reconstructed image;
wherein iteratively updating the reconstructed image comprises:
performing a first plurality of iterations of steps a., b., and c.;
processing the updated primal parameters, updated dual parameters, and updated reconstructed image to increase a resolution of the updated primal parameters, updated dual parameters, and updated reconstructed image; and
performing at least one additional iteration of steps a., b., and c.

23. A reconstruction node for image reconstruction using a learned iterative scheme, the reconstruction node comprising a memory and processing circuitry configured to cause the reconstruction node to:
obtain measured data defined in a dual space, the measured data relating to a primal space;
process the measured data to reduce a resolution of the measured data by a first factor;
initiate a reconstructed image in the primal space based on the processed measured data;
determine dual parameters defined in the dual space based on the processed measured data;
determine primal parameters defined in the primal space based on the initiated reconstructed image;
identify a plurality of primal patches, each primal patch representing a subvolume of the primal space, wherein the primal space is divided into the plurality of the primal patches;
identify a plurality of dual patches, each dual patch representing a subset of the dual space, wherein the dual space is divided into the plurality of the dual patches;
iteratively update the reconstructed image by iteration of:
a. applying a dual-space learned invertible operator to the dual parameters, in dependence on at least part of the dual parameters, to obtain updated dual parameters, wherein the dual-space learned invertible operator is calculated separately for each dual patch;
b. applying a primal-space learned invertible operator to the primal parameters, in dependence on at least part of the primal parameters, to obtain updated primal parameters, wherein the primal-space learned invertible operator is calculated separately for each primal patch;
c. updating the reconstructed image based on the updated primal parameters; and
outputting the updated reconstructed image;
wherein iteratively updating the reconstructed image comprises:
performing a first plurality of iterations of steps a., b., and c.;
processing the updated primal parameters, updated dual parameters, and updated reconstructed image to increase a resolution of the updated primal parameters, updated dual parameters, and updated reconstructed image; and
performing at least one additional iteration of steps a., b., and c.

24. The reconstruction node of claim 23, wherein the reconstruction node is included in a radiotherapy treatment apparatus.
